(19) United States
(12) Patent Application Publication
(10) Pub. No.: US 2026/0313478 A1
(43) Pub. Date: Oct. 8, 2026

(54) TECHNIQUES FOR DYNAMIC METRIC INDICATION FOR NETWORK INITIATED CELL SWITCHING

(71) Applicant: QUALCOMM Incorporated, San Diego, CA (US)

(72) Inventors: Kiran VENUGOPAL, Green Brook, NJ (US); Yan ZHOU, San Diego, CA (US); Jelena DAMNJANOVIC, Del Mar, CA (US)

(21) Appl. No.: 19/172,119

(22) Filed: Apr. 7, 2025

(51) Int. Cl. H04W 36/00; H04W 72/1263

(52) U.S. Cl. CPC H04W 36/0058; H04W 36/0072; H04W 72/1263

(57) ABSTRACT

Various aspects of the present disclosure generally relate to wireless communication. In some aspects, a user equipment (UE) may transmit, to a network node, a measurement report identifying a set of candidate cells for a handover in an order, wherein the order is associated with a metric, wherein the metric is determined dynamically. The UE may receive, from the network node, a handover command from a first cell to a second cell, wherein the second cell is selected from the set of candidate cells. Numerous other aspects are described.

### FIELD OF THE DISCLOSURE

Aspects of the present disclosure generally relate to wireless communication and specifically relate to techniques, apparatuses, and methods associated with dynamic metric indication for network initiated cell switching.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A user equipment (UE) may perform beam management operations to support Layer 1 or Layer 2 (L1/L2)-centric inter-cell mobility. L1/L2 signaling may be referred to as “lower layer” signaling. L1/L2 signaling may be used to activate or deactivate candidate cells in a set of cells configured for lower layer triggered mobility (LTM) or to provide reference signals for measurement by the UE, by which the UE may select a candidate beam as a target beam for a lower layer handover operation. Accordingly, L1/L2-centric inter-cell mobility may enable a UE to perform a cell switch via dynamic control signaling at lower layers (e.g., downlink control information (DCI) for L1 signaling or a medium access control (MAC) control element (MAC-CE) for L2 signaling), rather than semi-static Layer 3 (L3) radio resource control (RRC) signaling. Thus, L1/L2 centric inter-cell mobility may reduce latency, reduce overhead, or otherwise increase efficiency of the cell switch.

### SUMMARY

In some aspects, a method of wireless communication performed by a user equipment (UE) includes transmitting, to a network node, a measurement report identifying a set of candidate cells for a handover in an order, wherein the order is associated with a metric, wherein the metric is determined dynamically; and receiving, from the network node, a handover command from a first cell to a second cell, wherein the second cell is selected from the set of candidate cells.

In some aspects, a method of wireless communication performed by a network node includes receiving, from a UE, a measurement report identifying a set of candidate cells for a handover in an order, wherein the order is associated with a metric, wherein the metric is determined dynamically; and transmitting, to the UE, a handover command from a first cell to a second cell, wherein the second cell is selected from the set of candidate cells.

In some aspects, an apparatus for wireless communication at a UE includes one or more memories; and one or more processors, coupled to the one or more memories, configured to cause the UE to: transmit, to a network node, a measurement report identifying a set of candidate cells for a handover in an order, wherein the order is associated with a metric, wherein the metric is determined dynamically; and receive, from the network node, a handover command from a first cell to a second cell, wherein the second cell is selected from the set of candidate cells.

In some aspects, an apparatus for wireless communication at a network node includes one or more memories; and one or more processors, coupled to the one or more memories, configured to cause the network node to: receive, from a UE, a measurement report identifying a set of candidate cells for a handover in an order, wherein the order is associated with a metric, wherein the metric is determined dynamically; and transmit, to the UE, a handover command from a first cell to a second cell, wherein the second cell is selected from the set of candidate cells.

In some aspects, a non-transitory computer-readable medium storing a set of instructions for wireless communication includes one or more instructions that, when executed by one or more processors of a UE, cause the UE to: transmit, to a network node, a measurement report identifying a set of candidate cells for a handover in an order, wherein the order is associated with a metric, wherein the metric is determined dynamically; and receive, from the network node, a handover command from a first cell to a second cell, wherein the second cell is selected from the set of candidate cells.

In some aspects, a non-transitory computer-readable medium storing a set of instructions for wireless communication includes one or more instructions that, when executed by one or more processors of a network node, cause the network node to: receive, from a UE, a measurement report identifying a set of candidate cells for a handover in an order, wherein the order is associated with a metric, wherein the metric is determined dynamically; and transmit, to the UE, a handover command from a first cell to a second cell, wherein the second cell is selected from the set of candidate cells.

In some aspects, an apparatus for wireless communication includes means for transmitting, to a network node, a measurement report identifying a set of candidate cells for a handover in an order, wherein the order is associated with a metric, wherein the metric is determined dynamically; and means for receiving, from the network node, a handover command from a first cell to a second cell, wherein the second cell is selected from the set of candidate cells.

In some aspects, an apparatus for wireless communication includes means for receiving, from a UE, a measurement report identifying a set of candidate cells for a handover in an order, wherein the order is associated with a metric, wherein the metric is determined dynamically; and means for transmitting, to the UE, a handover command from a first cell to a second cell, wherein the second cell is selected from the set of candidate cells.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIGS. 2 and 3 are diagrams illustrating examples of Layer 1 or Layer 2 (L1/L2) inter-cell mobility.

FIG. 4 is a diagram illustrating an example associated with dynamic metric indication for network-initiated cell switching.

FIG. 5 is a diagram illustrating an example associated with dynamic metric indication for event-triggered cell switching.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

In some wireless communication systems, a user equipment (UE) may assess and report a signal quality of potential handover candidate cells. A report may include information identifying downlink measurements, such as a reference signal received power (RSRP), and may be used by a network node to make handover decisions. In scenarios where a UE is connected, the network node may configure the UE to measure and report on several candidate cells, which may operate at different frequencies. The UE reports a set quantity of cells, such as one or more cells with the best downlink RSRP, and the network node may initiate a cell switch to a target cell to serve both downlink (DL) and uplink (UL) traffic.

However, this approach, based on downlink metrics, may not be optimal in cases where there is asymmetry in uplink and downlink traffic. For example, an asymmetry may exist in terms of transmission power, coverage, signal-to-interference-plus-noise ratio (SINR), or throughput. An asymmetry can lead to suboptimal system performance, particularly in uplink-heavy traffic scenarios. Implementing a decoupled approach can introduces several issues. First, a network node may specify multiple physical cell identities (PCIs) to a UE to enable the selection of one cell for downlink and another for uplink, thereby increasing signaling overhead and necessitating the new cell switch command formats. Second, in deployments where traffic may be asymmetric, potential gains from a decoupled downlink/uplink cell switch may be limited. In other words, in some scenarios, performance gains may be achieved by switching to a cell with a higher demanded traffic, whether uplink or downlink.

Accordingly, one example of a technical problem for cell switching is achieving performance benefits of decoupled uplink/downlink cell switching while avoiding increased complexity and signaling overhead. Furthermore, it is desirable to ensure that a UE can report not only based on downlink metrics but also take into account uplink considerations, without overly complicating the reporting and handover processes.

Various aspects relate generally to improving handover decision-making in wireless communication systems by utilizing dynamic metrics for candidate cell evaluation. Some aspects more specifically relate to a UE transmitting, to a network node, a measurement report that identifies a set of candidate cells for handover, ordered according to a dynamically determined metric. The dynamically determined metric may include downlink or uplink cell metrics, or both, and may be based on network assistance information parameters such as cell loading, interference, throughput, or mobility parameters. In some aspects, the network node may transmit an indication of which metric or associated configuration to use or may transmit an indication of an event or condition that the UE is to use in determining which metric or associated configuration to use. The network node may transmit a handover command to switch the UE from a first cell to a second cell, selected from the set of candidate cells, based on a candidate cell report generated in connection with the dynamically determined metric.

In some aspects, the UE may receive configuration information indicating which metric should be used for the measurement report, which may vary based on traffic or coverage characteristics of the uplink or downlink. In this way, the UE may determine the metric that reflects current network conditions and user demands most accurately. In some aspects, a UE measurement report can be configured to include metric offsets, which may include either priority or scalar offsets, to account for varying cell loading and interference conditions, as described in more detail herein.

Particular aspects of the subject matter described in this disclosure can be implemented to realize one or more of the following potential technical benefits. The dynamic indication of whether to use downlink or uplink cell metrics for handover decisions allows a network node to optimize resource allocation by making handover determinations that consider current traffic demands or coverage needs. This can lead to improved network efficiency and resource utilization by optimizing handover decisions with respect to uplink and downlink asymmetries. In some aspects, a UE can adapt a measurement report to reflect the most up-to-date network conditions, which helps to conserve network resources by preventing unnecessary handovers and optimizing the selection of target cells based on real-time performance metrics. Additionally, in some aspects, a network node can dynamically instruct the UE on which set of assistance information to use for cell reporting, which may conserve processing resources by facilitating a more accurate determination of potential uplink and downlink performance, particularly in networks with variable traffic patterns or asymmetric load conditions. In this way, some aspects described herein may conserve processing resources, memory resources, or network resources, among other examples by enabling a more efficient handover procedure in wireless networks, without necessarily changing a reporting format and while maintaining compatibility with existing reporting frameworks.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

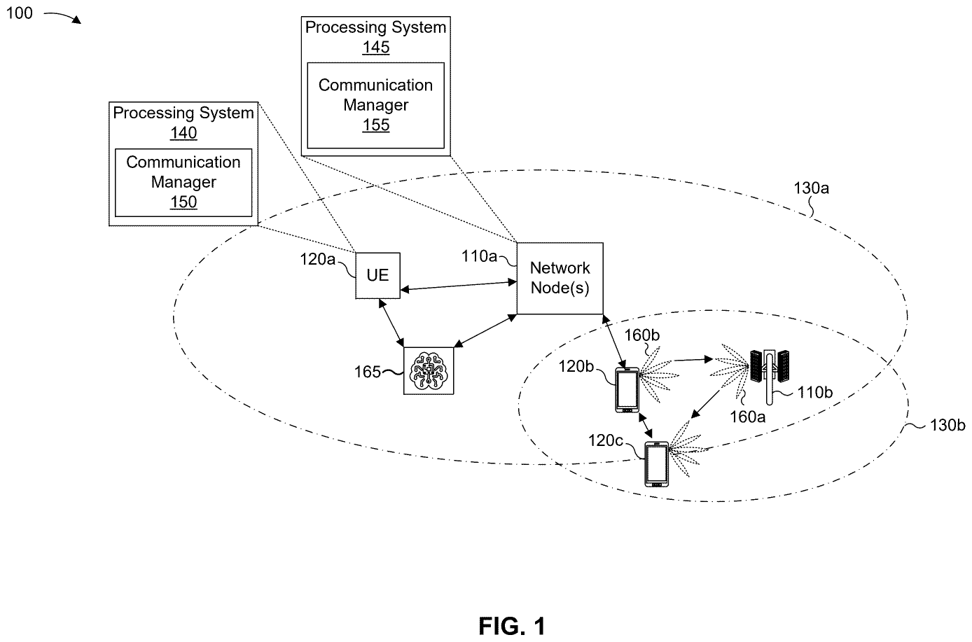

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a (which may provide a cell 130a) and a network node 110b (which may provide a cell 130b) (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) May perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may transmit, to a network node, a measurement report identifying a set of candidate cells for a handover in an order, wherein the order is associated with a metric, wherein the metric is determined dynamically; and receive, from the network node, a handover command from a first cell to a second cell, wherein the second cell is selected from the set of candidate cells. Additionally, or alternatively, the communication manager 150 may perform one or more other operations described herein.

In some aspects, the network node 110 may include a communication manager 155. As described in more detail elsewhere herein, the communication manager 155 may receive, from a UE, a measurement report identifying a set of candidate cells for a handover in an order, wherein the order is associated with a metric, wherein the metric is determined dynamically; and transmit, to the UE, a handover command from a first cell to a second cell, wherein the second cell is selected from the set of candidate cells. Additionally, or alternatively, the communication manager 155 may perform one or more other operations described herein.

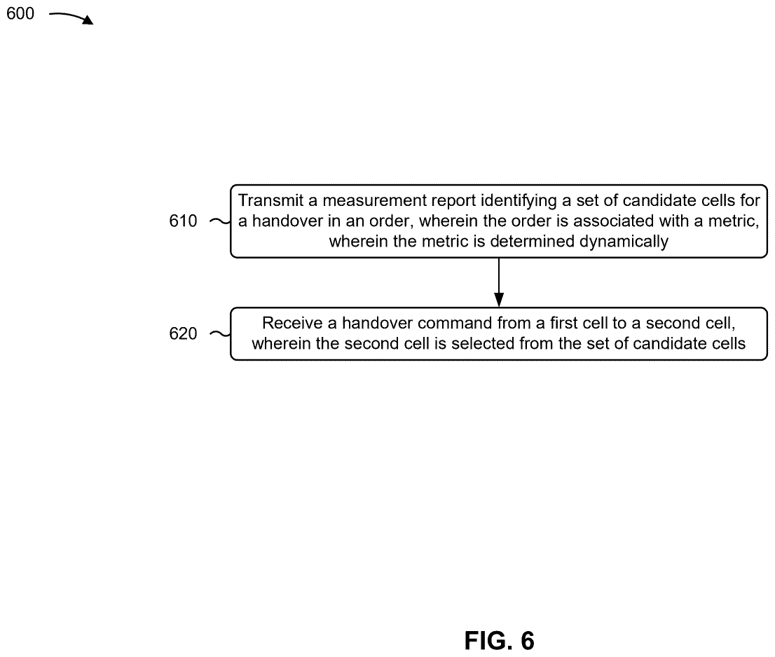

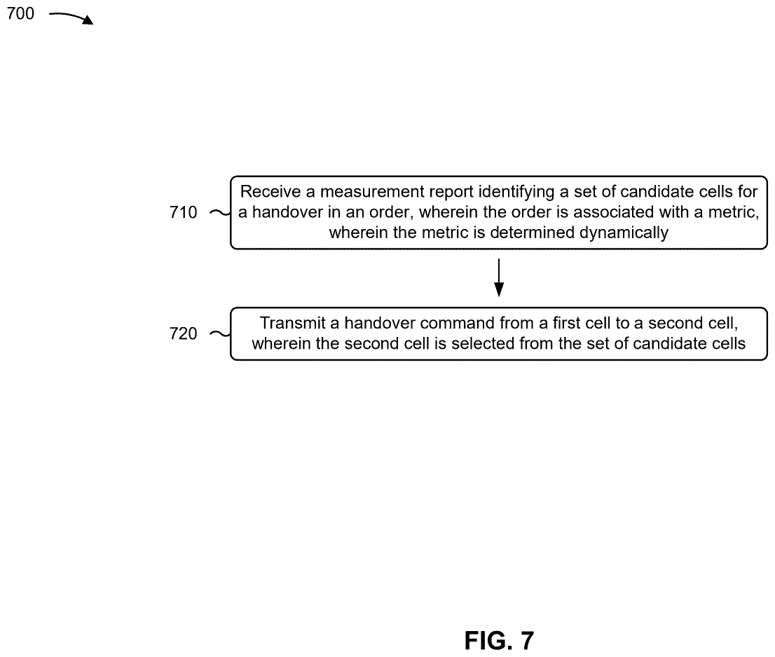

The network node 110, the processing system 145 of the network node 110, the UE 120, the processing system 140 of the UE 120, or any other component(s) of FIG. 1 may implement one or more techniques or perform one or more operations associated with dynamic metric indication for network initiated cell switching, as described in more detail elsewhere herein. For example, the processing system 145 of the network node 110, or the processing system 140 of the UE 120 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

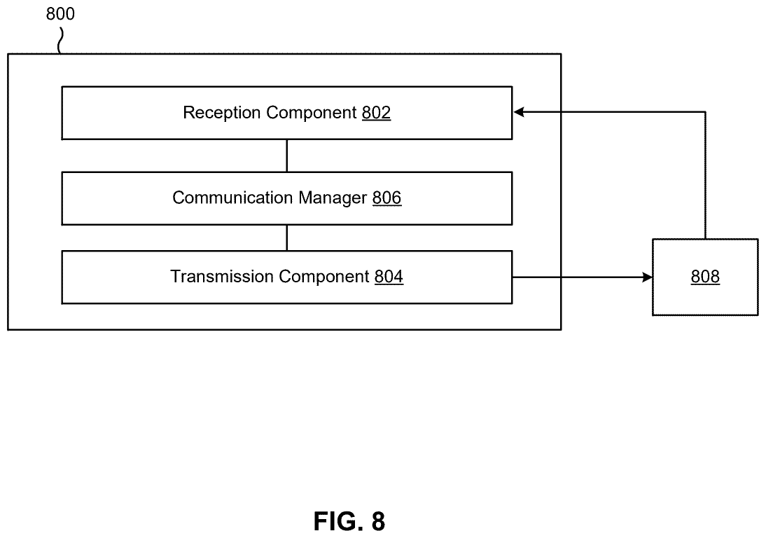

In some aspects, the UE 120 includes means for transmitting, to a network node, a measurement report identifying a set of candidate cells for a handover in an order, wherein the order is associated with a metric, wherein the metric is determined dynamically; or means for receiving, from the network node, a handover command from a first cell to a second cell, wherein the second cell is selected from the set of candidate cells. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

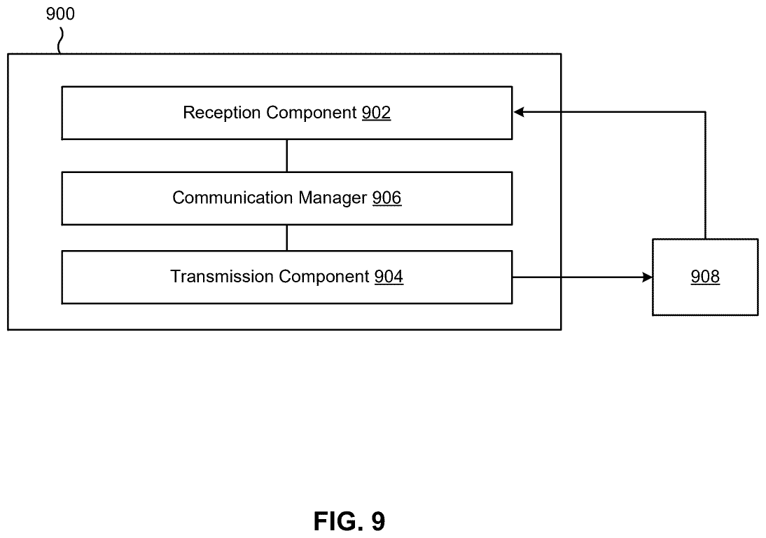

In some aspects, the network node 110 includes means for receiving, from a UE, a measurement report identifying a set of candidate cells for a handover in an order, wherein the order is associated with a metric, wherein the metric is determined dynamically; or means for transmitting, to the UE, a handover command from a first cell to a second cell, wherein the second cell is selected from the set of candidate cells. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

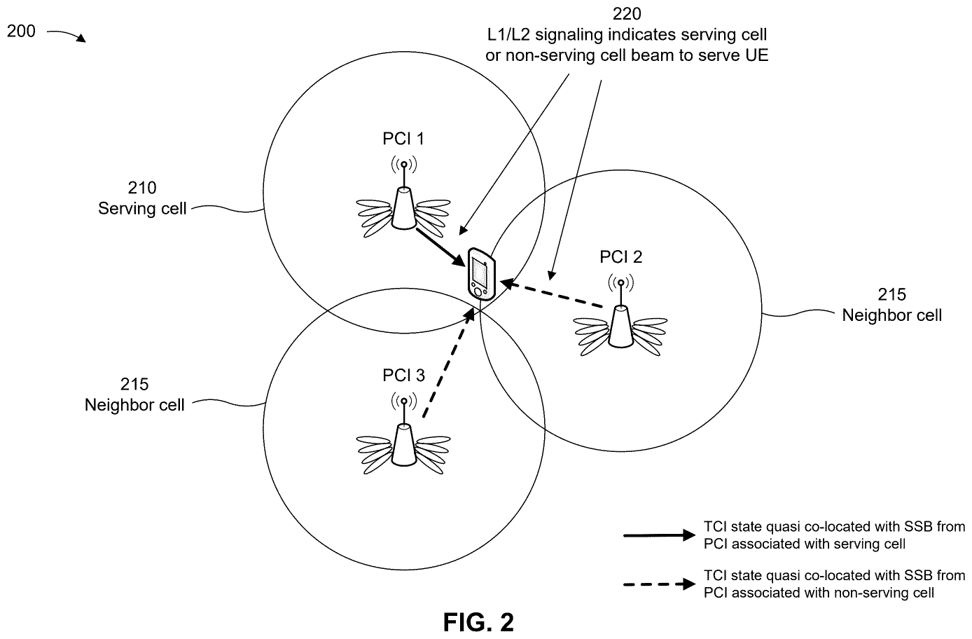

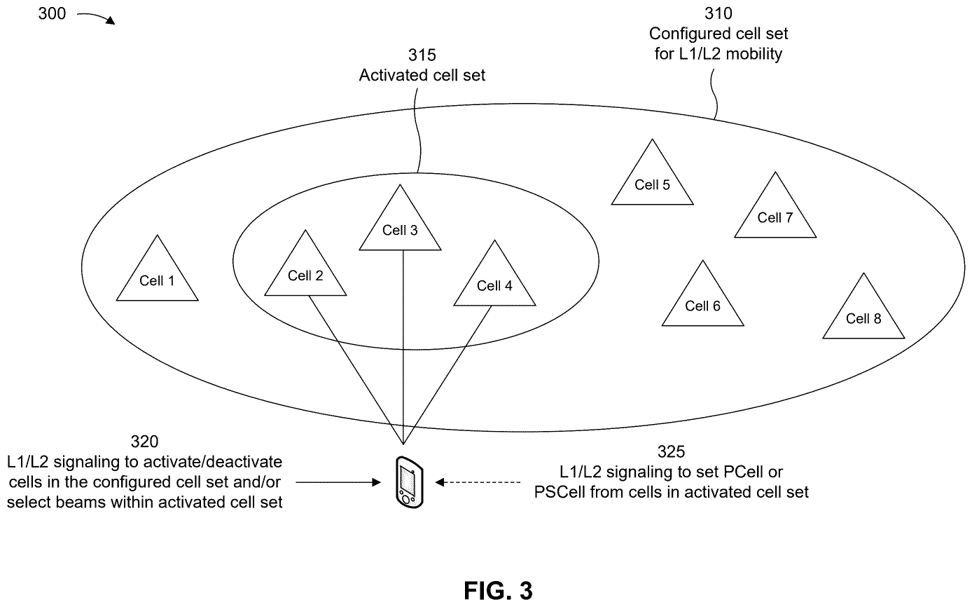

FIGS. 2 and 3 are diagrams illustrating examples 200 and 300 of L1/L2 inter-cell mobility.

In a wireless network, a UE and a network node may communicate on an access link using directional links (e.g., using high-dimensional phased arrays) to benefit from a beamforming gain or to maintain acceptable communication quality. The directional links, however, typically require fine alignment of transmit and receive beams, which may be achieved through a set of operations referred to as beam management or beam selection, among other examples. Further, a wireless network may support multi-beam operation at relatively high carrier frequencies (e.g., within FR2 or FR4), which may be associated with harsher propagation conditions than comparatively lower carrier frequencies. For example, relative to a sub-6 gigahertz (GHz) band (e.g., FR1), signals propagating in a millimeter wave frequency band may suffer from increased pathloss and severe channel intermittency, or may be blocked by objects commonly present in an environment surrounding the UE (e.g., a building, a tree, or a body of a user, among other examples). Accordingly, beam management is particularly important for multi-beam operation in a relatively high carrier frequency.

One possible enhancement for multi-beam operation at higher carrier frequencies is facilitation of efficient (e.g., low latency and low overhead) downlink or uplink beam management to support higher L1/L2-centric inter-cell mobility. Accordingly, one goal for L1/L2-centric inter-cell mobility is to enable a UE to perform a cell switch via dynamic control signaling at lower layers (e.g., DCI for L1 signaling or a MAC-CE for L2 signaling) rather than semi-static Layer 3 (L3) RRC signaling to reduce latency, reduce overhead, or otherwise increase efficiency of the cell switch.

For example, FIG. 2 illustrates an example 200 of a first L1/L2 inter-cell mobility technique, which may be referred to as beam-based inter-cell mobility, dynamic point selection based inter-cell mobility, or non-serving cell-based inter-cell mobility, among other examples. As described in further detail herein, the first L1/L2 inter-cell mobility technique may enable a network node to use L1 signaling (e.g., DCI) or L2 signaling (e.g., a MAC-CE) to indicate that a UE is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identity (PCI) associated with a serving cell. In contrast, in a wireless network that supports the first L1/L2 inter-cell mobility technique (e.g., as shown in FIG. 2), beam selection for control and data may be expanded to include any beams within a serving cell 210 or one or more non-serving neighbor cells 215 configured for L1/L2 inter-cell mobility.

For example, in the first L1/L2 inter-cell mobility technique shown in FIG. 2, a UE may be configured with a single serving cell 210, and may be further configured with a neighbor cell set that includes one or more non-serving cells 215 configured for L1/L2 inter-cell mobility. In general, the serving cell 210 and the non-serving cell(s) 215 configured for L1/L2 inter-cell mobility may be associated with a common CU and a common DU, or the serving cell 210 and the non-serving cell(s) 215 configured for L1/L2 inter-cell mobility may be associated with a common CU and different DUs. In some examples, as shown by reference number 220, a network node may trigger L1/L2 inter-cell mobility for a UE using L1/L2 signaling (e.g., DCI or a MAC-CE) that indicates a selected transmission configuration indication (TCI) state quasi co-located with a reference signal (e.g., a synchronization signal block (SSB)) associated with a PCI. For example, in FIG. 2, the UE may be communicating with the serving cell 210 using a TCI state that is quasi co-located with an SSB from a PCI associated with the serving cell 210 (e.g., shown as PCI 1 in FIG. 2), and L1/L2 signaling may trigger inter-cell mobility by indicating that the UE is to switch to communicating using a TCI state that is quasi co-located with an SSB from a PCI associated with a non-serving neighbor cell 215 (e.g., shown as PCI 2 in FIG. 2). Accordingly, in the first L1/L2 inter-cell mobility technique, the network node (e.g., the common CU controlling the serving cell 210 and the non-serving neighbor cell(s) 215) may use L1/L2 signaling to select a beam from either the serving cell 210 or a non-serving neighbor cell 215 to serve the UE.

In this way, relative to restricting L1/L2 beam selection to beams within the serving cell 210, the first L1/L2 inter-cell mobility technique may be more robust against blocking and may provide more opportunities for higher rank spatial division multiplexing across different cells. However, the first L1/L2 inter-cell mobility technique does not enable support for changing a special cell (SpCell) for a UE, where an SpCell may be a primary cell (PCell) or a primary secondary cell (PSCell). Rather, in the first L1/L2 inter-cell mobility technique, triggering an SpCell change is performed via a legacy L3 handover using RRC signaling. In this respect, the first L1/L2 inter-cell mobility technique is associated with a limitation in that L1/L2 signaling can only be used to indicate a beam from the serving cell 210 or a configured neighbor cell 215 while the UE is in the coverage area of the serving cell 210 (e.g., because L1/L2 signaling cannot be used to change the PCell or PSCell). Accordingly, FIG. 3B illustrates an example 300 of a second L1/L2 inter-cell mobility technique, which may be referred to as serving cell-based inter-cell mobility, among other examples. As described in further detail herein, the second L1/L2 inter-cell mobility technique may enable a network node to use L1/L2 signaling (e.g., DCI or a MAC-CE) to indicate control information associated with an activated cell set or a deactivated cell set or to indicate a change to an SpCell within the activated cell set.

For example, as shown in FIG. 3, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 3, a network node may configure a cell set 310 for L1/L2 inter-cell mobility (e.g., using RRC signaling). As further shown, an activated cell set 315 may include one or more cells in the configured cell set 310 that are activated and ready to use for data or control transfer. Accordingly, in the second L1/L2 inter-cell mobility technique, a deactivated cell set may include one or more cells that are included in the cell set 310 configured for L1/L2 inter-cell mobility but are not included in the activated cell set 315. However, the cells that are included in the deactivated cell set can be readily activated, and thereby added to the activated cell set 315, using L1/L2 signaling. Accordingly, as shown by reference number 320, L1/L2 signaling can be used for mobility management of the activated cell set 315. In some examples, L1/L2 signaling can be used to activate cells within the configured cell set 310 (e.g., to add cells to the activated cell set 315), to deactivate cells in the activated cell set 315, or to select beams within the cells included in the activated cell set 315. In this way, the second L1/L2 inter-cell mobility technique may enable seamless mobility among the cells included in the activated cell set 315 using L1/L2 signaling (e.g., using beam management techniques).

Furthermore, as shown by reference number 325, the second L1/L2 inter-cell mobility technique enables using L1/L2 signaling to set or change an SpCell (e.g., a PCell or PSCell) from the cells included in the activated cell set 315. Additionally, or alternatively, when the cell to become the new SpCell is in the deactivated cell set (e.g., is included in the cell set 310 configured for L1/L2 mobility but not the activated cell set 315), L1/L2 signaling can be used to move the cell from the deactivated cell set to the activated cell set 315 before further L1/L2 signaling is used to set the cell as the new SpCell. However, in the second L1/L2 inter-cell mobility technique, an L3 handover (e.g., using RRC signaling) is used to change the SpCell when the new SpCell is not included in the cell set 310 configured for L1/L2 inter-cell mobility. In such cases, RRC signaling associated with the L3 handover may be used to update the cells included in the cell set 310 configured for L1/L2 inter-cell mobility. Accordingly, L1/L2 inter-cell mobility can provide more efficient cell switching to support multi-beam operation, enabling lower latency and reduced overhead by using L1 signaling (e.g., DCI) or L2 signaling (e.g., a MAC-CE) rather than L3 signaling (e.g., RRC) to change the beam(s) that a UE uses to communicate over an access link.

As indicated above, FIGS. 2 and 3 are provided as examples. Other examples may differ from what is described with regard to FIGS. 2 and 3.

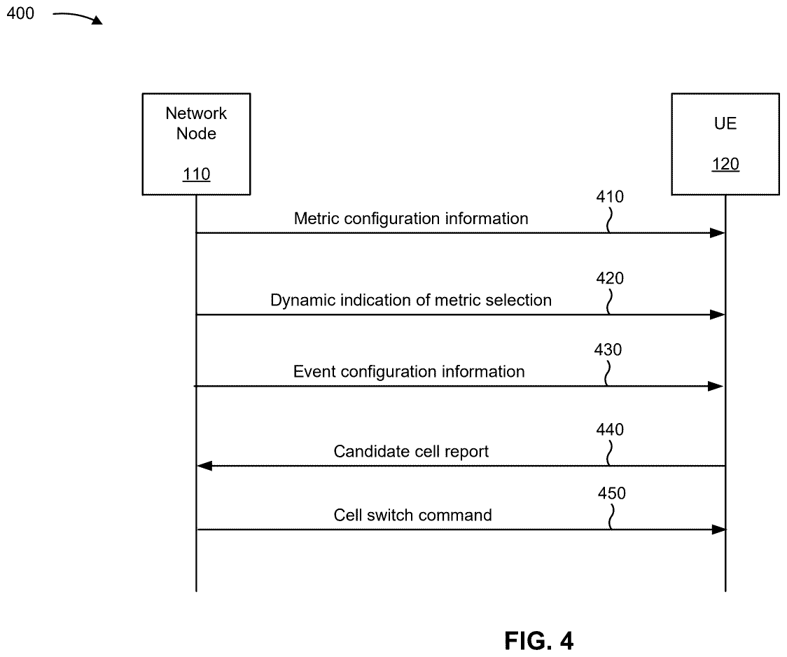

FIG. 4 is a diagram illustrating an example 400 associated with dynamic metric indication for network-initiated cell switching. As shown in FIG. 4, example 400 includes communication between a network node 110 and a UE 120.

As further shown in FIG. 4, and by reference number 410, the UE 120 may receive metric configuration information. For example, the UE 120 may receive metric configuration information from the network node 110. In some aspects, the network node 110 may transmit assistance information to the UE 120 to configure metric determination by the UE 120. For example, the network node 110 may configure a network assistance information message associated with configuring UE reporting on a set of metrics. In some aspects, the network node 110 may transmit a plurality of metric configurations to the UE 120. For example, the network node 110 may transmit, via one or more messages, a first configuration for one or more downlink metrics and a second configuration for one or more uplink metrics. In this case, the UE 120 may use the first configuration for measuring and ranking one or more downlink metrics (and associated cells) and the second configuration for measuring and ranking one or more uplink metrics (and associated cells).

In some aspects, the UE 120 may be configured with a particular type of metric to use for generating a candidate cell report. For example, the network assistance information message may be associated with configuring the UE 120 to use downlink cell loading, uplink cell loading, uplink interference, downlink throughput, or uplink throughput, among other examples. Additionally, or alternatively, the network assistance information message may include configuration information relating to a predicted cell load or network traffic to enable the UE 120 to determine an RSRP, an SINR, a throughput, an expected quality of service (QoS), an expected block error rate (BLER), or another metric on an uplink or a downlink. For example, the network node 110 may indicate a network node transmit power or a transmit power offset between uplink and downlink transmit powers to enable the UE 120 to determine an uplink RSRP. Additionally, or alternatively, the network node 110 may indicate an instantaneous or statistical interference metric (from a set of UEs or network nodes) to enable the UE 120 to determine an uplink SINR. Additionally, or alternatively, the network node 110 may indicate available uplink bandwidth, multi-input multiple-output (MIMO) support, a time division duplexing (TDD) pattern, an interference measurement, or a noise measurement, among other examples, to enable the UE 120 to determine an uplink throughput. Additionally, or alternatively, the network node 110 may indicate available downlink bandwidth, MIMO support, a TDD pattern, or an interference reference signal for measurement to enable the UE 120 to determine a downlink throughput.

In some aspects, the network node 110 may transmit the sets of assistance information (e.g., the metric configuration information) via separate report configurations for uplink and downlink, such as semi-persistent or aperiodic report configuration signaling. Additionally, or alternatively, the network node 110 may transmit the sets of assistance information via a single report configuration for uplink and downlink, such as via periodic, semi-persistent, or aperiodic report configuration signaling.

In some aspects, the network assistance information message is applicable to a particular type of handover. For example, the UE 120 may receive the network assistance information message to configure a candidate cell report for a network-triggered layer-3 (L3) handover, an LTM, a conditional handover (CHO), or a conditional LTM, among other examples. In some aspects, the network node 110 transmits the network assistance information message on a periodic basis or as a response to a UE request for network assistance information.

In some aspects, the UE 120 may be configured with a set of metric offsets. For example, the network node 110 may configure, for a downlink, a first type of metric offset (e.g., a priority metric offset) and a second type of metric offset (e.g., a scalar metric offset). In some aspects, the UE 120 may be configured with a set of metric offsets on a per candidate cell basis. In other words, the network node 110 may configure two sets of downlink metric offsets (pulk and polk) per candidate cell, to use for corresponding, respective downlink and uplink cell loading (or interference) factors. In some aspects, the downlink metric offsets can be configured with a candidate cell configuration, as a separate RRC messages on a per link direction basis, with a candidate cell configuration for a first link direction and via a separate RRC message conveying a separate offset list for a second link direction, or via a MAC-CE. When configured via a MAC-CE, the network node 110 may dynamically update the downlink metric offsets based on changes to network traffic or cell loading or based on a UE requesting configuration information. In this case, as described below, the network node 110 may dynamically indicate which metric offset to use.

In some aspects, the network node 110 may transmit the information identifying the plurality of configurations (e.g., the network assistance information) via a particular type of message. For example, the network node 110 may transmit a network assistance information message, a radio resource control message, a system information block message, or another type of message to convey the plurality of metric configurations to the UE 120.

As further shown in FIG. 4, and by reference number 420, in some aspects the UE 120 may receive a dynamic indication of a metric selection. For example, the UE 120 may receive the dynamic indication of the metric selection from the network node 110. In some aspects, the network node 110 may transmit a dynamic indication of which metric the UE 120 is to use for candidate cell reporting. For example, the network node 110 may transmit an indication of a selection of the first configuration (e.g., for the one or more downlink metrics) or a selection of the second configuration (e.g., for the one or more uplink metrics). In this case, the network node 110 may convey the indication of the selection via dynamic signaling, such as DCI or a MAC-CE. For example, the network node 110 may transmit a 1-bit DCI group-common indicator or a UE-specific indicator to select a configuration for a metric. Additionally, or alternatively, the network node 110 may transmit a dedicated MAC-CE message to convey a selection of a configuration from a metric from among the plurality of configurations that the network node 110 configured for the UE 120. In this case, a received dynamic selection of a configuration triggers the UE 120 to activate or trigger a corresponding aperiodic or semi-persistent report configuration (e.g., when separate report configurations are provided for uplink and downlink) or triggers the UE 120 to select a corresponding part of a single report configuration (e.g., when a single report configuration is provided for both uplink and downlink). In some aspects, the network node 110 may transmit an indication of a metric offset to use. For example, the network node 110 may dynamically indicate whether to use a priority metric offset or a scalar metric offset.

In some aspects, the network node 110 may select which configuration to activate (e.g., which configuration of which metric to select for the UE 120) based on one or more statistical network conditions. For example, the network node 110 may use statistical information or predictions associated with a traffic pattern or a network loading to select which metric the UE 120 is to use for a candidate cell report.

As further shown in FIG. 4, and by reference number 430, in some aspects, the UE 120 may receive event configuration information. For example, the UE 120 may receive the event configuration information from the network node 110. The event configuration information may include information indicating one or more parameters for selecting a metric to report for candidate cell reporting. In other words, additionally or alternatively to a dynamic indication of the metric selection, the UE 120 may receive information indicating a condition upon which the UE 120 is to select the first configuration (e.g., for the one or more downlink metrics) or the second configuration (e.g., for the one or more uplink metrics). In this case, the condition may relate to an event or a measurement. For example, when the UE 120 measures relative network traffic on a downlink and an uplink as being asymmetric toward more traffic on the downlink, the UE 120 may determine to use the one or more downlink metrics for candidate cell reporting. Alternatively, when the UE 120 detects a communication failure event associated with an uplink, the UE 120 may determine to use the one or more uplink metrics for candidate cell reporting.

In some aspects, the network node 110 may configure a set of downlink metric offsets in connection with an event configuration. For example, as described above, when the network node 110 configures the set of downlink metric offsets, the network node 110 may dynamically signal which metric offset to use. Alternatively, the network node 110 may dynamically signal an event that the UE 120 is to use for selecting a metric offset. In other words, the network node 110 may transmit an event configuration identifying a condition for selecting an offset. As an example, the network node 110 may configure the UE 120 such that when an uplink required data rate is greater than a configured minimum uplink data rate, the UE 120 is to use an offset for uplink factors. Alternatively, the network node 110 may configure the UE 120 such that when a downlink required rate is greater than a configured minimum downlink rate, the UE 120 is to use an offset for downlink factors. Alternatively, the network node 110 may configure the UE 120 such that when both the downlink required rate and the uplink required rate are greater than corresponding configured minimum rates, the UE 120 is to use one or more of the offsets. In some aspects, the network node 110 may configure conditions relating to a UE traffic pattern, application type, or QoS parameter for selecting which metric to select (e.g., which corresponding assistance information configuring one or more metrics to select).

As further shown in FIG. 4, and by reference number 440, the UE 120 may transmit a candidate cell report. For example, the UE 120 may transmit the candidate cell report to the network node 110. In this case, the candidate cell report may be transmitted as a periodic candidate cell report message, a semi-persistent candidate cell report message, or an aperiodic candidate cell report message.

In some aspects, the UE 120 may select a metric to use for the candidate cell report. For example, the UE 120 may select a downlink metric or an uplink metric based on the dynamic indication of which metric to use or an event configuration for selecting which metric to use, as described above. In this case, based on selecting the metric, the UE 120 may determine the metric for a set of candidate cells and may generate a candidate cell report using the metric. For example, the UE 120 may rank a set of candidate cells with respect to the metric, select a configured quantity L of candidate cells with a best ranking, and report the selected candidate cells with the best ranking via a cell reporting message. In other words, rather than reporting the best L candidate cells according to RSRP, the UE 120 may select a set of cells based on a configured metric (e.g., SINR, uplink throughput, downlink throughput, among other examples) and may report RSRPs for the selected cells (e.g., rather than the configured metric). Additionally, or alternatively, the UE 120 may select a set of cells based on a configured metric (e.g., a downlink metric, uplink metric, or combination of uplink and downlink metrics) and may report the configured metric for the selected cell.

In some aspects, the UE 120 may generate the candidate cell report message based on a metric offset, as described above. For example, based on a latest configured two sets of downlink metric offsets and a dynamic indication selecting a metric (e.g., measured RSRP), the UE 120 may scale or shift values used for reporting a candidate cell. For example, for a candidate cell k, the UE 120 may determine a reported RSRP as:

$${RSRP}_{k}^{reported} = {RSRP}_{k}^{a c t u a l} \times {ρ}_{k}^{U L / D L}$$

where

$${RSRP}_{k}^{reported}$$

is an RSRP value reported for cell k in the candidate cell report,

$${RSRP}_{k}^{a c t u a l}$$

is a measured RSRP for cell k, and

$${ρ}_{k}^{U L / D L}$$

represents a selected uplink or downlink metric offset.

In some aspects, the UE 120 may transmit information identifying a report format for the candidate cell report message. For example, when the UE 120 is transmitting an event-triggered candidate cell report message (e.g., based on an event configuration), the UE 120 may transmit information to the network node 110 indicating a format of the candidate cell report message. In this case, the UE 120 may transmit padding bits configured to indicate which metric is being reported. Additionally, or alternatively, the UE 120 may use a configured resource that corresponds to the metric being reported or the format of the candidate cell report message (e.g., based on the UE 120 having been configured with different dedicated resources for different metrics or report formats). Additionally, or alternatively, the UE 120 may use a configured demodulation reference signal (DMRS) pattern that corresponds to the metric being reported or the format of the candidate cell report message (e.g., based on the UE 120 having been configured with different DMRS patterns for different metrics or report formats).

As further shown in FIG. 4, and by reference number 450, the UE 120 may receive a cell switch command. For example, the UE 120 may receive the cell switch command from the network node 110. In some aspects, the UE 120 may receive a command to switch to a target cell from the candidate cell report. For example, the network node 110 may transmit a cell switch command to trigger a handover of the UE 120 from a first cell to a second cell. In some aspects, the handover may be an LTM handover, a layer-3 (L3) handover, or a conditional handover (CHO).

As indicated above, FIG. 4 is provided as an example. Other examples may differ from what is described with respect to FIG. 4.

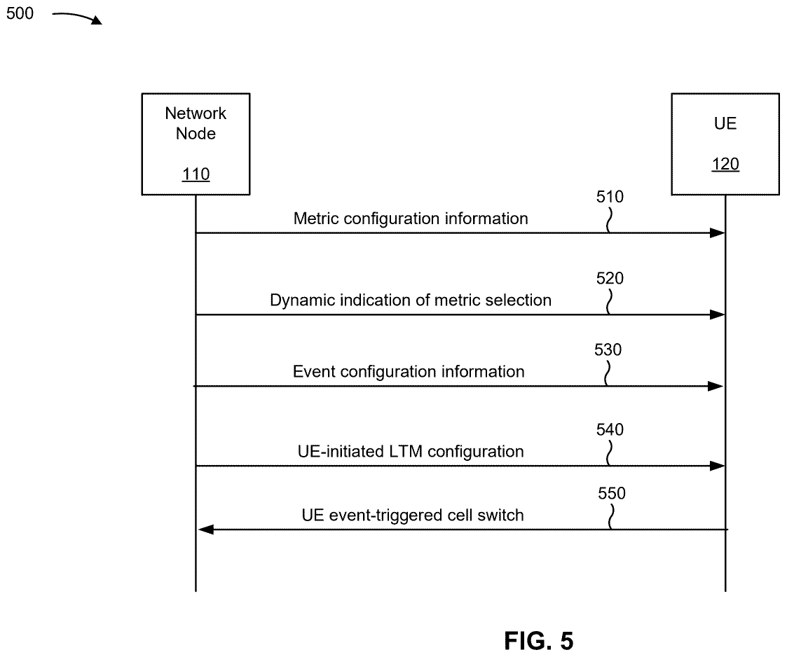

FIG. 5 is a diagram illustrating an example 500 associated with dynamic metric indication for event-triggered cell switching. As shown in FIG. 5, example 500 includes communication between a network node 110 and a UE 120.

As further shown in FIG. 5, and by reference number 510, the UE 120 may receive metric configuration information. For example, the UE 120 may receive metric configuration information from the network node 110. In some aspects, the network node 110 may transmit assistance information to the UE 120 to configure metric determination by the UE 120. For example, the network node 110 may configure a network assistance information message associated with configuring UE reporting on a set of metrics, as described in more detail above.

As further shown in FIG. 5, and by reference number 520, in some aspects the UE 120 may receive a dynamic indication of a metric selection. For example, the UE 120 may receive the dynamic indication of the metric selection from the network node 110. In some aspects, the network node 110 may transmit a dynamic indication of which metric the UE 120 is to use for candidate cell reporting. For example, the network node 110 may transmit an indication of a selection of the first configuration (e.g., for the one or more downlink metrics) or a selection of the second configuration (e.g., for the one or more uplink metrics), as described in more detail above.

As further shown in FIG. 5, and by reference number 530, in some aspects, the UE 120 may receive event configuration information. For example, the UE 120 may receive the event configuration information from the network node 110. The event configuration information may include information indicating one or more parameters for selecting a metric to report for candidate cell reporting, as described in more detail above.

As further shown in FIG. 5, and by reference number 540, the UE 120 may receive a configuration of UE-initiated LTM reporting. For example, the UE 120 may receive configuration information conveying an event configuration for triggering UE-initiated LTM reporting or configuration information identifying a set of resources for transmitting a UE-triggered cell switch message, among other examples.

As further shown in FIG. 5, and by reference number 550, the UE 120 may transmit a UE-triggered cell switch message. For example, the UE 120 may transmit the UE-triggered cell switch message to the network node 110. In some aspects, the UE 120 may transmit the UE-triggered cell switch message based on detecting an occurrence of an event. For example, based on the event configuration, the UE 120 may detect an event, such as a threshold network metric, and may initiate LTM. Based on initiating LTM, the UE 120 may transmit a cell switch message, which may include information associated with a configured and selected metric, as described above, such as an uplink metric or a downlink metric.

As indicated above, FIG. 5 is provided as an example. Other examples may differ from what is described with respect to FIG. 5.

FIG. 6 is a diagram illustrating an example process 600 performed, for example, at a UE or an apparatus of a UE. Example process 600 is an example where the apparatus or the UE (e.g., UE 120) performs operations associated with dynamic metric indication for network-initiated cell switching.

As shown in FIG. 6, in some aspects, process 600 may include transmitting a measurement report identifying a set of candidate cells for a handover in an order, wherein the order is associated with a metric, wherein the metric is determined dynamically (block 610). For example, the UE (e.g., using transmission component 804 or communication manager 806, depicted in FIG. 8) may transmit a measurement report identifying a set of candidate cells for a handover in an order, wherein the order is associated with a metric, wherein the metric is determined dynamically, as described above.

As further shown in FIG. 6, in some aspects, process 600 may include receiving a handover command from a first cell to a second cell, wherein the second cell is selected from the set of candidate cells (block 620). For example, the UE (e.g., using reception component 802 or communication manager 806, depicted in FIG. 8) may receive a handover command from a first cell to a second cell, wherein the second cell is selected from the set of candidate cells, as described above.

Process 600 may include additional aspects, such as any single aspect or any combination of aspects described below or in connection with one or more other processes described elsewhere herein.

In a first aspect, the metric includes at least one of a downlink cell metric or an uplink cell metric.

In a second aspect, alone or in combination with the first aspect, process 600 includes receiving configuration information identifying an indication of a selection of the metric with which the order is associated, and determining the metric based on the indication of the selection.

In a third aspect, alone or in combination with one or more of the first and second aspects, the selection is associated with a traffic or coverage characteristic of at least one of an uplink or a downlink.

In a fourth aspect, alone or in combination with one or more of the first through third aspects, the metric is associated with at least one of a network assistance information parameter, a cell loading parameter, an interference parameter, a throughput parameter, or a mobility parameter.

In a fifth aspect, alone or in combination with one or more of the first through fourth aspects, the handover command is associated with at least one of an L3 based mobility event, a lower layer triggered mobility event, or a UE initiated handover.

In a sixth aspect, alone or in combination with one or more of the first through fifth aspects, process 600 includes receiving first configuration information associated with configuring a downlink cell metric, receiving second configuration information associated with configuring a uplink cell metric, and receiving selection information indicating a selection of the first configuration information or the second configuration information for use in transmitting the measurement report.

In a seventh aspect, alone or in combination with one or more of the first through sixth aspects, the selection information includes an explicit selection or a set of criteria for selection.

In an eighth aspect, alone or in combination with one or more of the first through seventh aspects, the selection information includes configuration information for UE initiated mobility.

In a ninth aspect, alone or in combination with one or more of the first through eighth aspects, the metric includes at least one metric offset, wherein the at least one metric offset includes a priority metric offset or a scalar metric offset.

In a tenth aspect, alone or in combination with one or more of the first through ninth aspects, the metric is configured on a per candidate cell basis.

In an eleventh aspect, alone or in combination with one or more of the first through tenth aspects, the metric is configured via at least one of a candidate cell configuration message, a radio resource control message, a direction-specific configuration message, an offset configuration message, or a dynamic message.

In a twelfth aspect, alone or in combination with one or more of the first through eleventh aspects, the metric is associated with at least one of a reference signal received power metric, a signal-to-interference-plus-noise ratio metric, or a throughput metric.

In a thirteenth aspect, alone or in combination with one or more of the first through twelfth aspects, the measurement report includes at least one of an indication of the order of the set of candidate cells, or an indication of the metric.

In a fourteenth aspect, alone or in combination with one or more of the first through thirteenth aspects, the measurement report is associated with at least one of a set of padding bits associated with an indication of the metric, a demodulation reference signal associated with the indication of the metric or a resource allocation associated with the indication of the metric.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with dynamic metric indication for network initiated cell switching.

As shown in FIG. 7, in some aspects, process 700 may include receiving a measurement report identifying a set of candidate cells for a handover in an order, wherein the order is associated with a metric, wherein the metric is determined dynamically (block 710). For example, the network node (e.g., using reception component 902 or communication manager 906, depicted in FIG. 9) may receive a measurement report identifying a set of candidate cells for a handover in an order, wherein the order is associated with a metric, wherein the metric is determined dynamically, as described above.

As further shown in FIG. 7, in some aspects, process 700 may include transmitting, to the UE, a handover command from a first cell to a second cell, wherein the second cell is selected from the set of candidate cells (block 720). For example, the network node (e.g., using transmission component 904 or communication manager 906, depicted in FIG. 9) may transmit, to the UE, a handover command from a first cell to a second cell, wherein the second cell is selected from the set of candidate cells, as described above.

Process 700 may include additional aspects, such as any single aspect or any combination of aspects described below or in connection with one or more other processes described elsewhere herein.

In a first aspect, the metric includes at least one of a downlink cell metric or an uplink cell metric.

In a second aspect, alone or in combination with the first aspect, process 700 includes transmitting configuration information identifying an indication of a selection of the metric with which the order is associated.

In a third aspect, alone or in combination with one or more of the first and second aspects, the selection is associated with a traffic or coverage characteristic of at least one of an uplink or a downlink.

In a fourth aspect, alone or in combination with one or more of the first through third aspects, the metric is associated with at least one of a network assistance information parameter, a cell loading parameter, an interference parameter, a throughput parameter, or a mobility parameter.

In a fifth aspect, alone or in combination with one or more of the first through fourth aspects, the handover command is associated with at least one of a layer 3 (L3) based mobility event, a lower layer triggered mobility event, or a UE initiated handover.

In a sixth aspect, alone or in combination with one or more of the first through fifth aspects, process 700 includes transmitting first configuration information associated with configuring a downlink cell metric, transmitting second configuration information associated with configuring a uplink cell metric, and transmitting selection information indicating a selection of the first configuration information or the second configuration information for use in transmitting the measurement report.

In a seventh aspect, alone or in combination with one or more of the first through sixth aspects, the selection information includes an explicit selection or a set of criteria for selection.

In an eighth aspect, alone or in combination with one or more of the first through seventh aspects, the selection information includes configuration information for UE initiated mobility.

In a ninth aspect, alone or in combination with one or more of the first through eighth aspects, the metric includes at least one metric offset, wherein the at least one metric offset includes a priority metric offset or a scalar metric offset.

In a tenth aspect, alone or in combination with one or more of the first through ninth aspects, the metric is configured on a per candidate cell basis.

In an eleventh aspect, alone or in combination with one or more of the first through tenth aspects, the metric is configured via at least one of a candidate cell configuration message, a radio resource control message, a direction-specific configuration message, an offset configuration message, or a dynamic message.

In a twelfth aspect, alone or in combination with one or more of the first through eleventh aspects, the metric is associated with at least one of a reference signal received power metric, a signal-to-interference-plus-noise ratio metric, or a throughput metric.

In a thirteenth aspect, alone or in combination with one or more of the first through twelfth aspects, the measurement report includes at least one of an indication of the order of the set of candidate cells, or an indication of the metric.

In a fourteenth aspect, alone or in combination with one or more of the first through thirteenth aspects, the measurement report is associated with at least one of a set of padding bits associated with an indication of the metric, a demodulation reference signal associated with the indication of the metric or a resource allocation associated with the indication of the metric.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit, to a network node, a measurement report identifying a set of candidate cells for a handover in an order, wherein the order is associated with a metric, wherein the metric is determined dynamically. The reception component 802 may receive, from the network node, a handover command from a first cell to a second cell, wherein the second cell is selected from the set of candidate cells.

The reception component 802 may receive configuration information identifying an indication of a selection of the metric with which the order is associated. The communication manager 806 may determine the metric based on the indication of the selection. The reception component 802 may receive first configuration information associated with configuring a downlink cell metric. The reception component 802 may receive second configuration information associated with configuring a uplink cell metric. The reception component 802 may receive selection information indicating a selection of the first configuration information or the second configuration information for use in transmitting the measurement report.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive, from a UE, a measurement report identifying a set of candidate cells for a handover in an order, wherein the order is associated with a metric, wherein the metric is determined dynamically. The transmission component 904 may transmit, to the UE, a handover command from a first cell to a second cell, wherein the second cell is selected from the set of candidate cells.

The transmission component 904 may transmit configuration information identifying an indication of a selection of the metric with which the order is associated. The transmission component 904 may transmit first configuration information associated with configuring a downlink cell metric. The transmission component 904 may transmit second configuration information associated with configuring a uplink cell metric. The transmission component 904 may transmit selection information indicating a selection of the first configuration information or the second configuration information for use in transmitting the measurement report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, to a network node, a measurement report identifying a set of candidate cells for a handover in an order, wherein the order is associated with a metric, wherein the metric is determined dynamically; and receiving, from the network node, a handover command from a first cell to a second cell, wherein the second cell is selected from the set of candidate cells.

Aspect 2: The method of Aspect 1, wherein the metric includes at least one of a downlink cell metric or an uplink cell metric.

Aspect 3: The method of any of Aspects 1-2, further comprising: receiving configuration information identifying an indication of a selection of the metric with which the order is associated; and determining the metric based on the indication of the selection.

Aspect 4: The method of Aspect 3, wherein the selection is associated with a traffic or coverage characteristic of at least one of an uplink or a downlink.

Aspect 5: The method of any of Aspects 1-4, wherein the metric is associated with at least one of: a network assistance information parameter, a cell loading parameter, an interference parameter, a throughput parameter, or a mobility parameter.

Aspect 6: The method of any of Aspects 1-5, wherein the handover command is associated with at least one of: a layer 3 (L3) based mobility event, a lower layer triggered mobility event, or a UE initiated handover.

Aspect 7: The method of any of Aspects 1-6, further comprising: receiving first configuration information associated with configuring a downlink cell metric; receiving second configuration information associated with configuring a uplink cell metric; and receiving selection information indicating a selection of the first configuration information or the second configuration information for use in transmitting the measurement report.

Aspect 8: The method of Aspect 7, wherein the selection information includes an explicit selection or a set of criteria for selection.

Aspect 9: The method of Aspect 7, wherein the selection information includes configuration information for UE initiated mobility.

Aspect 10: The method of any of Aspects 1-9, wherein the metric includes at least one metric offset, wherein the at least one metric offset includes a priority metric offset or a scalar metric offset.

Aspect 11: The method of any of Aspects 1-10, wherein the metric is configured on a per candidate cell basis.

Aspect 12: The method of any of Aspects 1-11, wherein the metric is configured via at least one of: a candidate cell configuration message, a radio resource control message, a direction-specific configuration message, an offset configuration message, or a dynamic message.

Aspect 13: The method of any of Aspects 1-12, wherein the metric is associated with at least one of: a reference signal received power metric, a signal-to-interference-plus-noise ratio metric, or a throughput metric.

Aspect 14: The method of any of Aspects 1-13, wherein the measurement report includes at least one of: an indication of the order of the set of candidate cells, or an indication of the metric.

Aspect 15: The method of any of Aspects 1-14, wherein the measurement report is associated with at least one of: a set of padding bits associated with an indication of the metric, a demodulation reference signal associated with the indication of the metric or a resource allocation associated with the indication of the metric.

Aspect 16: A method of wireless communication performed by a network node, comprising: receiving, from a user equipment (UE), a measurement report identifying a set of candidate cells for a handover in an order, wherein the order is associated with a metric, wherein the metric is determined dynamically; and transmitting, to the UE, a handover command from a first cell to a second cell, wherein the second cell is selected from the set of candidate cells.

Aspect 17: The method of Aspect 16, wherein the metric includes at least one of a downlink cell metric or an uplink cell metric.

Aspect 18: The method of any of Aspects 16-17, further comprising: transmitting configuration information identifying an indication of a selection of the metric with which the order is associated.

Aspect 19: The method of Aspect 18, wherein the selection is associated with a traffic or coverage characteristic of at least one of an uplink or a downlink.

Aspect 20: The method of any of Aspects 16-19, wherein the metric is associated with at least one of: a network assistance information parameter, a cell loading parameter, an interference parameter, a throughput parameter, or a mobility parameter.

Aspect 21: The method of any of Aspects 16-20, wherein the handover command is associated with at least one of: a layer 3 (L3) based mobility event, a lower layer triggered mobility event, or a UE initiated handover.

Aspect 22: The method of any of Aspects 16-21, further comprising: transmitting first configuration information associated with configuring a downlink cell metric; transmitting second configuration information associated with configuring a uplink cell metric; and transmitting selection information indicating a selection of the first configuration information or the second configuration information for use in transmitting the measurement report.

Aspect 23: The method of Aspect 22, wherein the selection information includes an explicit selection or a set of criteria for selection.

Aspect 24: The method of Aspect 22, wherein the selection information includes configuration information for UE initiated mobility.

Aspect 25: The method of any of Aspects 16-24, wherein the metric includes at least one metric offset, wherein the at least one metric offset includes a priority metric offset or a scalar metric offset.

Aspect 26: The method of any of Aspects 16-25, wherein the metric is configured on a per candidate cell basis.

Aspect 27: The method of any of Aspects 16-26, wherein the metric is configured via at least one of: a candidate cell configuration message, a radio resource control message, a direction-specific configuration message, an offset configuration message, or a dynamic message.

Aspect 28: The method of any of Aspects 16-27, wherein the metric is associated with at least one of: a reference signal received power metric, a signal-to-interference-plus-noise ratio metric, or a throughput metric.

Aspect 29: The method of any of Aspects 16-28, wherein the measurement report includes at least one of: an indication of the order of the set of candidate cells, or an indication of the metric.

Aspect 30: The method of any of Aspects 16-29, wherein the measurement report is associated with at least one of: a set of padding bits associated with an indication of the metric, a demodulation reference signal associated with the indication of the metric or a resource allocation associated with the indication of the metric.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 38: A device comprising a processing system that includes one or more processors and one or more code-storing memories coupled with the one or more processors, the processing system configured to cause the device to perform the method of one or more of Aspects 1-30.

Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,”’ may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, to a network node, a measurement report identifying a set of candidate cells for a handover in an order, wherein the order is associated with a metric, wherein the metric is determined dynamically; and
receive, from the network node, a handover command from a first cell to a second cell, wherein the second cell is selected from the set of candidate cells.

2. The UE of claim 1, wherein the metric includes at least one of a downlink cell metric or an uplink cell metric.

3. The UE of claim 1, wherein the processing system is configured to cause the UE to:
receive configuration information identifying an indication of a selection of the metric with which the order is associated; and
determine the metric based on the indication of the selection.

4. The UE of claim 3, wherein the selection is associated with a traffic or coverage characteristic of at least one of an uplink or a downlink.

5. The UE of claim 1, wherein the metric is associated with at least one of:
a network assistance information parameter,
a cell loading parameter,
an interference parameter,
a throughput parameter, or
a mobility parameter.

6. The UE of claim 1, wherein the handover command is associated with at least one of:
a layer 3 (L3) based mobility event,
a lower layer triggered mobility event, or
a UE initiated handover.

7. The UE of claim 1, wherein the processing system is configured to cause the UE to:
receive first configuration information associated with configuring a downlink cell metric;
receive second configuration information associated with configuring a uplink cell metric; and
receive selection information indicating a selection of the first configuration information or the second configuration information for use in transmitting the measurement report.

8. The UE of claim 7, wherein the selection information includes an explicit selection or a set of criteria for selection.

9. The UE of claim 7, wherein the selection information includes configuration information for UE initiated mobility.

10. The UE of claim 1, wherein the metric includes at least one metric offset, wherein the at least one metric offset includes a priority metric offset or a scalar metric offset.

11. The UE of claim 1, wherein the metric is configured on a per candidate cell basis.

12. The UE of claim 1, wherein the metric is configured via at least one of:
a candidate cell configuration message,
a radio resource control message,
a direction-specific configuration message,
an offset configuration message, or
a dynamic message.

13. The UE of claim 1, wherein the metric is associated with at least one of:
a reference signal received power metric,
a signal-to-interference-plus-noise ratio metric, or
a throughput metric.

14. The UE of claim 1, wherein the measurement report includes at least one of:
an indication of the order of the set of candidate cells, or
an indication of the metric.

15. The UE of claim 1, wherein the measurement report is associated with at least one of:
a set of padding bits associated with an indication of the metric,
a demodulation reference signal associated with the indication of the metric or
a resource allocation associated with the indication of the metric.

16. A network node, comprising:
a processing system that includes one or more processors and one or more code-storing memories coupled with the one or more processors, the processing system configured to cause the network node to:
receive, from a user equipment (UE), a measurement report identifying a set of candidate cells for a handover in an order, wherein the order is associated with a metric, wherein the metric is determined dynamically; and
transmit, to the UE, a handover command from a first cell to a second cell, wherein the second cell is selected from the set of candidate cells.

17. The network node of claim 16, wherein the metric includes at least one of a downlink cell metric or an uplink cell metric.

18. The network node of claim 16, wherein the processing system is configured to cause the network node to:
transmit configuration information identifying an indication of a selection of the metric with which the order is associated.

19. The network node of claim 18, wherein the selection is associated with a traffic or coverage characteristic of at least one of an uplink or a downlink.

20. The network node of claim 16, wherein the metric is associated with at least one of:
a network assistance information parameter,
a cell loading parameter,
an interference parameter,
a throughput parameter, or
a mobility parameter.

21. The network node of claim 16, wherein the handover command is associated with at least one of:
a layer 3 (L3) based mobility event,
a lower layer triggered mobility event, or
a UE initiated handover.

22. The network node of claim 16, wherein the processing system is configured to cause the network node to:
transmit first configuration information associated with configuring a downlink cell metric;
transmit second configuration information associated with configuring a uplink cell metric; and
transmit selection information indicating a selection of the first configuration information or the second configuration information for use in transmitting the measurement report.

23. The network node of claim 22, wherein the selection information includes an explicit selection or a set of criteria for selection.

24. The network node of claim 22, wherein the selection information includes configuration information for UE initiated mobility.

25. The network node of claim 16, wherein the metric includes at least one metric offset, wherein the at least one metric offset includes a priority metric offset or a scalar metric offset.

26. The network node of claim 16, wherein the metric is configured on a per candidate cell basis.

27. The network node of claim 16, wherein the metric is configured via at least one of:
a candidate cell configuration message,
a radio resource control message,
a direction-specific configuration message,
an offset configuration message, or
a dynamic message.

28. The network node of claim 16, wherein the metric is associated with at least one of:
a reference signal received power metric,
a signal-to-interference-plus-noise ratio metric, or
a throughput metric.

29. A method of wireless communication performed by a user equipment (UE), comprising:
transmitting, to a network node, a measurement report identifying a set of candidate cells for a handover in an order, wherein the order is associated with a metric, wherein the metric is determined dynamically; and
receiving, from the network node, a handover command from a first cell to a second cell, wherein the second cell is selected from the set of candidate cells.

30. A method of wireless communication performed by a network node, comprising:
receiving, from a user equipment (UE), a measurement report identifying a set of candidate cells for a handover in an order, wherein the order is associated with a metric, wherein the metric is determined dynamically; and
transmitting, to the UE, a handover command from a first cell to a second cell, wherein the second cell is selected from the set of candidate cells.
